(19) United States
(12) Patent Application Publication
(10) Pub. No.: US 2026/0012573 A1
(43) Pub. Date: Jan. 8, 2026

(54) METHODS AND APPARATUSES FOR ENCODING AND DECODING AN IMAGE OR A VIDEO

(71) Applicant: InterDigital CE Patent Holdings, SAS, Paris (FR)

(72) Inventors: Philippe Bordes, Laille (FR); Karam Naser, Mouaze (FR); Thierry Dumas, Rennes (FR); Franck Galpin, Thorigne-Fouillard (FR)

(21) Appl. No.: 18/876,056

(22) PCT Filed: Jun. 20, 2023
(86) PCT No.: PCT/EP2023/066630

§ 371 Date: Dec. 17, 2024

(30) Foreign Application Priority Data
Jun. 21, 2022 (EP) 22305896.7
Sep. 30, 2022 (EP) 22306458.5

(51) Int. Cl. H04N 19/105; H04N 19/167; H04N 19/176; H04N 19/186

(52) U.S. Cl. CPC H04N 19/105; H04N 19/167; H04N 19/176; H04N 19/186

(57) ABSTRACT

A method and an apparatus for encoding and decoding a block of an image or a video wherein chroma samples of the block are intra-predicted using cross-component model and reconstructed luma samples of the block. The cross-component model is obtained for the block based on a reference area that is modified according to at least one characteristic of the block. In an embodiment, reconstructed luma and chroma samples in a reference area are selected for deriving the cross-component model based on the reconstructed luma samples of the block. In another embodiment, the reference area is modified based on an indicator signaled for the block.

### CROSS REFERENCE TO RELATED APPLICATIONS

This application claims the priority to European Application No. 22305896.7, filed on 21 Jun. 2022, and to European Application No. 22306458.5 filed on 30 Sep. 2022, which are incorporated herein by reference in their entirety.

### TECHNICAL FIELD

The present embodiments generally relate to video compression. The present embodiments relate to a method and an apparatus for determining a prediction for chroma samples of block of an image/video to encode/decode using cross-component model.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an aspect, a method for predicting chroma samples of a block using a cross-component model is provided.

In some embodiments, the method comprises obtaining, for at least one block of an image, at least one cross-component model from reference luma and chroma samples, based on reconstructed luma samples of the block, and predicting chroma samples of the block based on the at least one cross-component model and the reconstructed luma samples of the block.

In some embodiments, the method comprises, for at least one block of an image, identifying a reference area for determining at least one cross-component model from reference luma and chroma samples, modifying the reference area based on at least one characteristic of the block, obtaining the at least one cross-component model, based on the modified reference area, predicting chroma samples of the block based on the at least one cross-component model and reconstructed luma samples of the block.

According to another aspect, a method for encoding an image or a video is provided wherein chroma samples of a block of the image or video are predicted using any one of the embodiments of the method for predicting chroma samples described herein.

According to another aspect, a method for decoding an image or a video is provided wherein chroma samples of a block of the image or video are predicted using any one of the embodiments of the method for predicting chroma samples described herein.

According to another aspect, an apparatus for predicting chroma samples of a block using a cross-component model is provided. In some embodiments, the apparatus comprises one or more processors operable to obtain, for at least one block of an image, at least one cross-component model from reference luma and chroma samples, based on reconstructed luma samples of the block, and predict chroma samples of the block based on the at least one cross-component model and the reconstructed luma samples of the block.

In some embodiments, the apparatus comprises one or more processors operable to, for at least one block of an image, identify a reference area for determining at least one cross-component model from reference luma and chroma samples, modify the reference area based on at least one characteristic of the block, obtain the at least one cross-component model, based on the modified reference area, predict chroma samples of the block based on the at least one cross-component model and reconstructed luma samples of the block.

In an embodiment, the one or more processors are operable to encode an image or a video to which the block belongs. In an embodiment, the one or more processors are operable to decode an image or a video to which the block belongs.

In an embodiment, reference luma and chroma samples are reconstructed luma samples and corresponding reconstructed chroma samples located in a reference area of the block.

In some embodiments, the at least one characteristic of the block comprises at least one of reconstructed luma samples of the block, an indicator determined for the block (coded for the block or inferred for the block), a cross-component model signaled for the block.

In an embodiment, obtaining the at least one cross-component model based on reconstructed luma samples of the block comprises selecting in the reference area of the block, reference luma samples and co-located chroma samples, based at least on reconstructed luma samples of the block, and determining the at least one cross-component model based on the selected reference luma samples and co-located chroma samples.

In a variant, selecting in the reference area of the block, reference luma samples and co-located chroma samples, is responsive to a determination that the reference luma samples have same characteristics as the reconstructed luma samples of the block.

Further embodiments that can be used alone or in combination are described herein.

One or more embodiments also provide a computer program comprising instructions which when executed by one or more processors cause the one or more processors to perform the method for predicting chroma samples or encoding/decoding image or video data according to any of the embodiments described herein. One or more of the present embodiments also provide a non-transitory computer readable medium and/or a computer readable storage medium having stored thereon instructions for predicting chroma samples or encoding/decoding image or video data according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder within which aspects of the present embodiments may be implemented.

FIG. 3 illustrates a block diagram of an embodiment of a video decoder within which aspects of the present embodiments may be implemented.

FIG. 4 illustrates examples of cross-component linear model prediction modes.

FIG. 5 illustrates an example of classifying the neighboring samples into two groups in a variant of a cross-component linear model prediction mode.

FIG. 6 illustrates an example of multiple reference lines for MLR intra prediction.

FIG. 7 illustrates an example of spatial part of a convolutional filter in a variant of the convolutional cross-component model for intra prediction.

FIG. 8 illustrates an example of a reference area with its padding used to derive filter coefficients in a variant of a cross-component model prediction mode.

FIG. 9 illustrates an example of a method for chroma prediction using cross-component model.

FIG. 10 illustrates examples of derived CC linear model using different sets of luma reference samples.

FIG. 11 illustrates an example of a method for predicting chroma samples of a block using cross-component intra prediction according to an embodiment.

FIG. 12A illustrates an example of a method for encoding chroma samples of a block using cross-component intra prediction according to an embodiment.

FIG. 12B illustrates an example of a method for decoding chroma samples of a block using cross-component intra prediction according to an embodiment.

FIG. 13 illustrates an example of a method for chroma prediction using cross-component model according to an embodiment.

FIG. 14 illustrates an example of a method for chroma prediction using cross-component model according to another embodiment.

FIG. 15 illustrates an example of a method for chroma prediction using cross-component model according to another embodiment.

FIG. 16 illustrates an example of a method for chroma prediction using cross-component model according to another embodiment.

FIG. 17 illustrates an example of a method for chroma prediction using cross-component model according to another embodiment.

FIG. 18 illustrates an example of a CU reconstructed luma samples and subset of reference reconstructed luma samples delineated with a dotted box forming an area used for determining the characteristics used for selecting the reference samples.

FIG. 19 illustrates another example of a CU reconstructed luma samples and subset of reference reconstructed luma samples delineated with a dotted box forming an area used for determining the characteristics used for selecting the reference samples.

FIG. 20 illustrates an example of a method for chroma prediction using cross-component model according to another embodiment.

FIG. 21 illustrates a block diagram of a system within which aspects of the present embodiments may be implemented, according to another embodiment.

FIG. 22 shows two remote devices communicating over a communication network in accordance with an example of the present principles.

FIG. 23 shows the syntax of a signal in accordance with an example of the present principles.

FIG. 24 illustrates an example of different regions used to derive the CC-model.

FIG. 25 illustrates an example of a method for chroma prediction using cross-component model according to another embodiment.

FIG. 26 illustrates an example of extended regions that can be used to derive the CC-model.

FIG. 27 illustrates an example of regions that can be used to derive the CC-model.

FIG. 28 illustrates another example of extended regions that can be used to derive the CC-model.

FIG. 29 illustrates an example of a method for prediction using cross-component model according to another embodiment.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

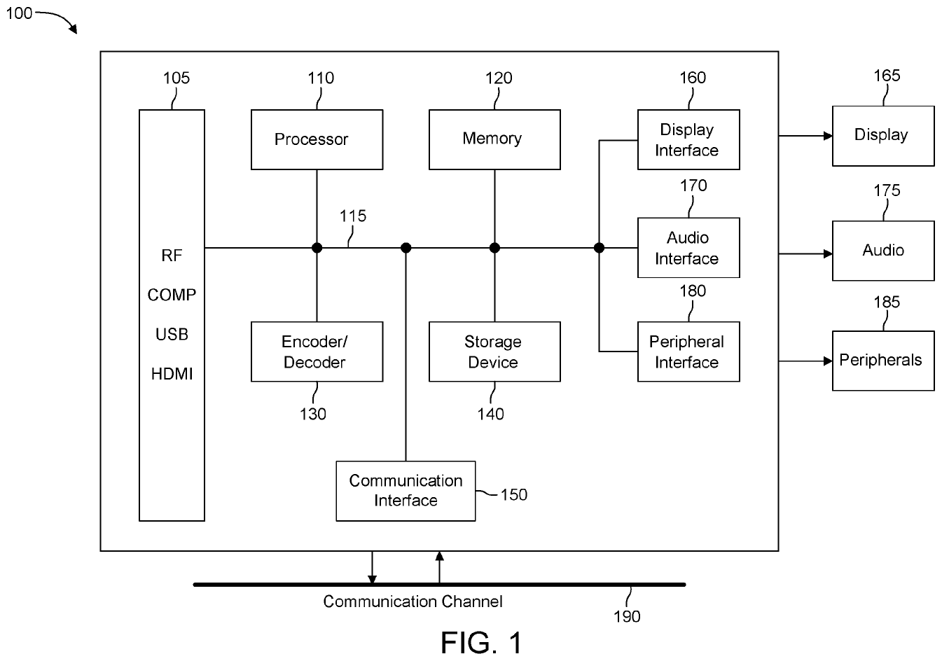

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner.

Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

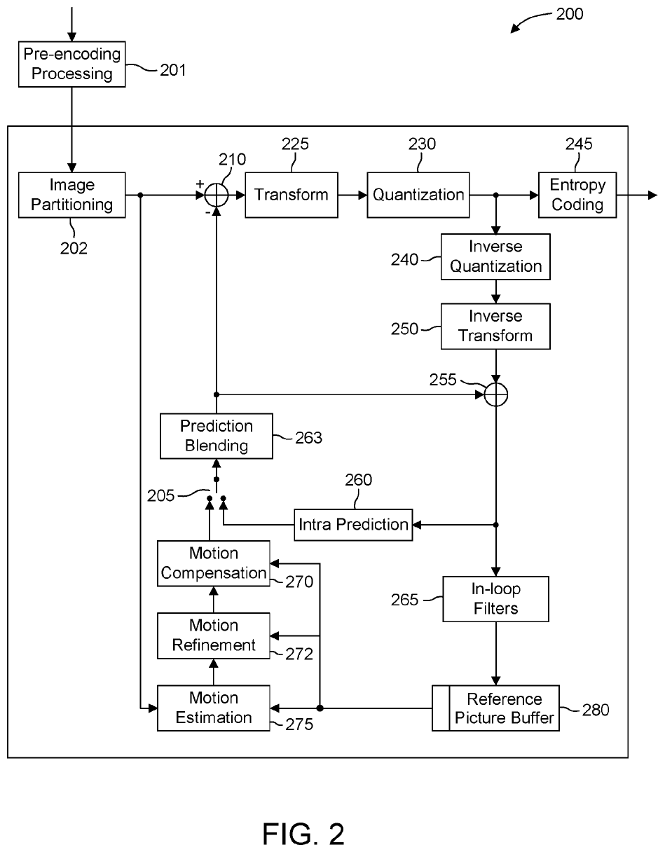

FIG. 2 illustrates an encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or a VVC standard or an encoder employing technologies similar to HEVC or VVC, such as an encoder under development by JVET (Joint Video Exploration Team).

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs (Coding units) or blocks. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

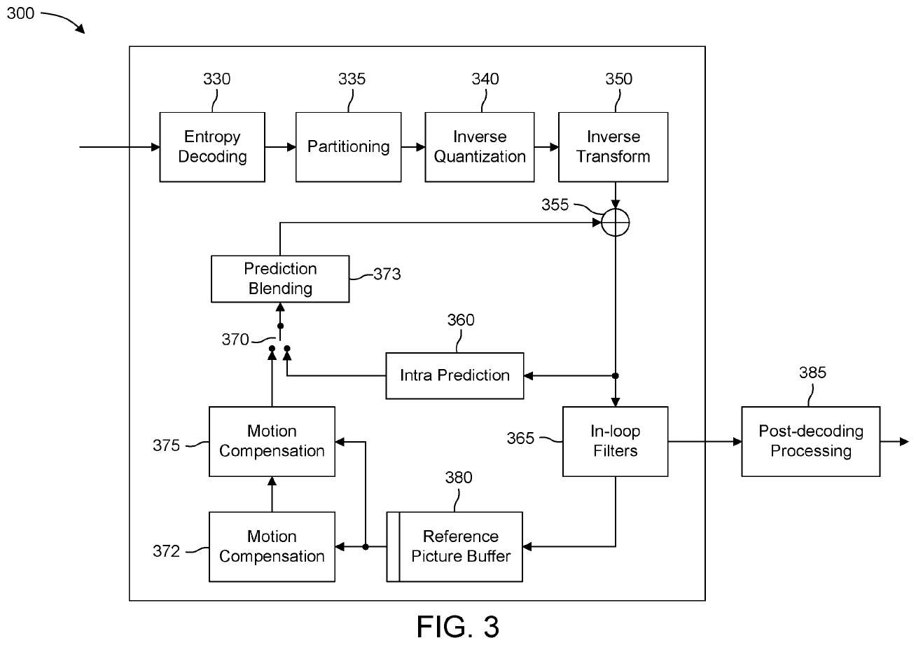

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

### Cross-Component Linear Model (CCLM) for Intra Prediction

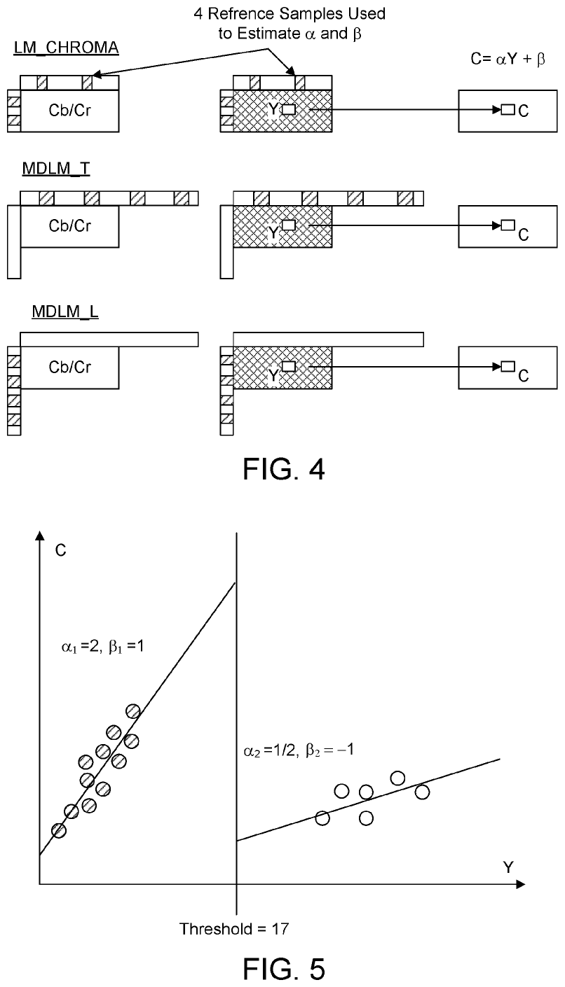

To reduce the cross-component redundancy, a Cross-Component Linear Model (CCLM) prediction mode is used in the VVC standard (Versatile Video Coding, Standard ITU-T H.266, ISO/EC23090-3, 2020), for which the chroma samples are predicted based on the reconstructed luma samples of the same CU by using a linear model as follows:

$${pred}_{C} ( i , j ) = α \cdot {rec}_{L}^{′} ( i , j ) + β \qquad ( eq . 1 )$$

where pred_{C}(i,j) represents the predicted chroma samples in a CU (e.g. Cb or Cr components, or U or V components of the CU) and rec_{L}(i,j) represents the reconstructed luma samples of the same CU (e.g. L or Y component of the CU). Depending on the chroma format, the reconstructed luma samples can be possibly down-sampled, in case of 4:2:0 or 4:2:2 chroma format for example. In VVC, the CCLM parameters (a and p) are derived with at most four neighboring chroma samples and their corresponding down-sampled luma samples. There exists 3 CCLM modes (LM_CHROMA, MDLM_T, MDLM_L) that differ from the location of the neighboring chroma samples, as depicted in FIG. 4. The CCLM mode to be used is coded per CU.

The neighboring luma samples at the selected positions are down-sampled and compared to find two smaller values: x⁰_{A} and x¹_{A}, and two larger values: x⁰_{B} and x¹_{B}. Their corresponding chroma sample values are denoted as y⁰_{A}, y¹_{A}, y⁰_{B} and y¹_{B}. Then Xₐ, X_{b}, Yₐ and Y_{b} are derived as follows:

$$\begin{matrix}{X}_{a} = ( {x}_{A}^{0} + {x}_{A}^{1} + 1 ) ≫ 1 ; {X}_{b} = ( {x}_{B}^{0} + {x}_{B}^{1} + 1 ) ≫ 1 ; \\ {Y}_{a} = ( {y}_{A}^{0} + {y}_{A}^{1} + 1 ) ≫ 1 ; {Y}_{b} = ( {y}_{B}^{0} + {y}_{B}^{1} + 1 ) ≫ 1\end{matrix} \qquad ( eq . 2 )$$

Finally, the linear model parameters a and p are obtained according to the following equations.

$$α = ( {Y}_{a} - {Y}_{b} ) / ( {X}_{a} - {X}_{b} ) \qquad ( eq . 3 )$$

$$β = {Y}_{b} - α \cdot {X}_{b} \qquad ( eq . 4 )$$

### Multi-Model LM (MMLM) and Other CCLM Variants

There exist several variants to CCLM, where the location and/or the number of the neighboring samples used to derive the cross-component model, and/or the method to derive the cross-component linear model parameters (α, β), and/or the luma down-sampling filter, may differ.

For example, the parameters of the cross-component linear model can be derived from causal reconstructed samples around the current CU.

In another example, in ECM (M. Coban, F.Le Leannec, K. Naser, J. Ström, “Algorithm description of Enhanced Compression Model 4 (ECM 4),” document JVET-Y2025, 23rd Meeting, by teleconference, 7-16 Jul. 2021), the CCLM included in VVC is extended by adding three cross-component Multi-model LM (MMLM) modes (K. Zhang, J. Chen, L. Zhang, M. Karczewicz, “Enhanced Cross-component Linear Model Intra-prediction,” document JVET-D0110). In each MMLM mode, the reconstructed neighboring samples are classified into two classes using a value (threshold) which is the average of the luma reconstructed neighboring samples. FIG. 5 illustrates an example of classifying the neighboring samples into two groups. The threshold is determined as the average value of the neighboring reconstructed luma samples. A neighboring luma sample having a value that is lower than or equals to the threshold is classified into the first group, a neighboring luma sample having a value that is higher than the threshold is classified into the second group. Two CC-models are derived: one for each class from the neighboring luma and chroma samples of the class. The linear CC-model of each class is derived using the Least-Mean-Square (LMS) method. The choice whether to use single model (LM_CHROMA, MDLM_T, MDLM_L) or multi-model (MMLM_CHROMA, MMLM_T, MMLM_L) may be done as a function of implicit parameters (for example: if the current block size is superior to a given value, then the multi-model prediction mode is used). In other implementations, the choice whether to use single or multi-model is coded in the bitstream with one indicator (for instance a flag).

The luma samples of the CU whose chroma samples are to be predicted are also classified based on the same rule for the classification of neighboring luma samples. To predict a chroma sample of the CU, the linear CC-model of the class to which the corresponding luma sample belongs is used.

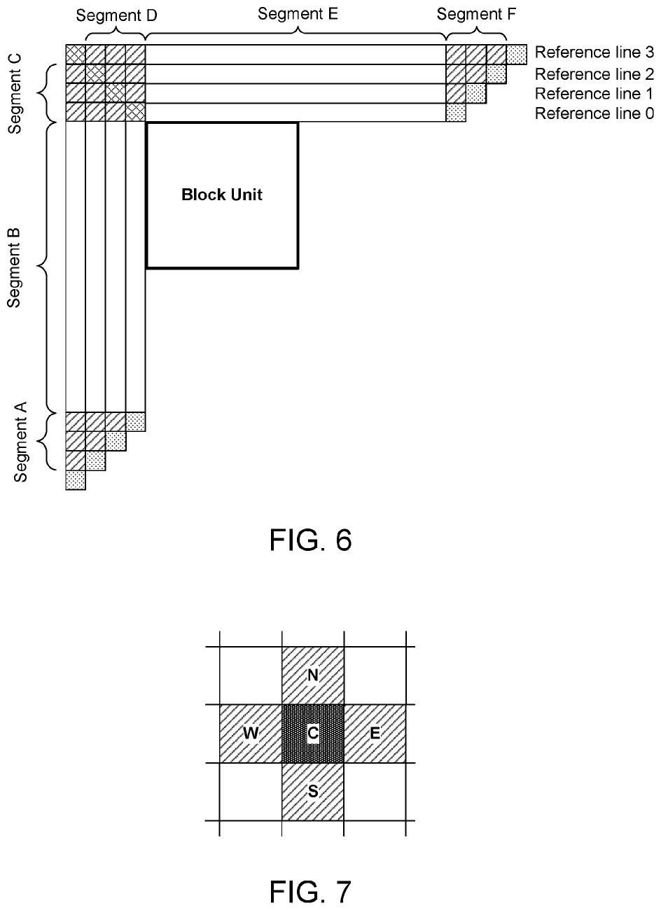

In the multiple reference line (MRL) variant, the intra prediction uses more reference lines for intra prediction. In FIG. 6, an example of 4 reference lines is depicted, where the samples of segments A and F are not fetched from reconstructed neighboring samples but padded with the closest samples from Segment B and E, respectively. HEVC intra-picture prediction uses the nearest reference line (i.e., reference line 0). In MRL, 2 additional lines (reference line 1 and reference line 3) are used. The index of the selected reference line is signaled and used to generate intra predictor.

### Convolutional Cross-Component Model (CCCM) for Intra Prediction

The convolutional cross-component model (CCCM) (P. Astola, J. Lainema, R. Youvalari, A. Aminlou, K. Panusopone, “AHG12: Convolutional cross-component model (CCCM) for intra prediction,” document JVET-Z0064, 26th Meeting, by teleconference, 20-29 Apr. 2022) predicts chroma samples from reconstructed luma samples in a similar spirit as done by CCLM. As with CCLM, the reconstructed luma samples are possibly down-sampled depending on chroma format, to match the lower resolution chroma grid when chroma sub-sampling is used.

Also, similarly to CCLM, there is an option of using a single CC-model or multi-model variant of CCCM. The multi-model variant uses two CC-models, one CC-model derived for samples above the average luma reference value and another CC-model for the rest of the samples (following the spirit of the CCLM design). Multi-model CCCM mode can be selected for PUs (Prediction Units) which have at least 128 reference samples available.

CCCM uses a convolutional 7-tap filter consisting of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated in FIG. 7.

The nonlinear term P is represented as power of two of the center luma sample C and scaled to the sample value range of the content:

$$P = ( C * C + 512 ) ≫ 10.$$

midVal being the middle value of the range of values of the content represented at bitDepth.

That is, for 10-bit content P is calculated as:

$$P = ( C * C + midVal ) ≫ bitDepth , ,$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$pred Chroma Val = {c}_{0} C + {c}_{1} N + {c}_{2} S + {c}_{3} E + c 4 W + {c}_{5} P + {c}_{6} B .$$

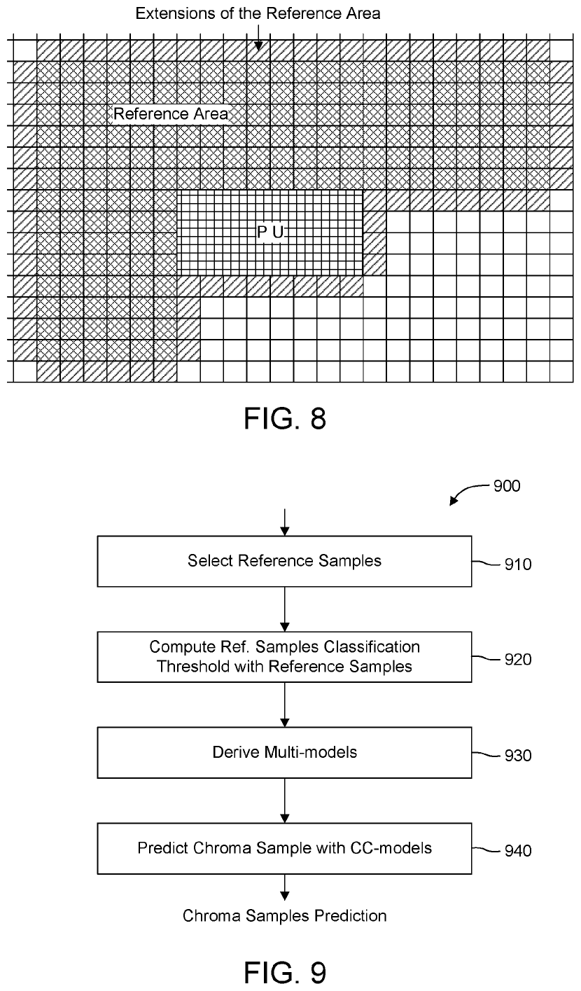

The filter coefficients ci are calculated by minimizing MSE between predicted and reconstructed chroma samples in the reference area. FIG. 8 illustrates the reference area which consists of 6 lines/columns of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output.

$$denote ai = C , N , S , E , W , P , B$$

$${a}_{i} = \{ \begin{matrix}i = 0 : C \\ i = 1 : N \\ i = 2 : S \\ i = 3 : E \\ i = 4 : W \\ i = 5 : P \\ i = 6 : B\end{matrix}$$

Autocorrelation matrix is LDL decomposed and the final filter coefficients are calculated using back-substitution. The process follows roughly the calculation of the ALF filter coefficients in ECM, however LDL decomposition (a.k.a alternative Cholesky decomposition) was chosen instead of Cholesky decomposition to avoid using square root operations. The calculation uses only integer arithmetic.

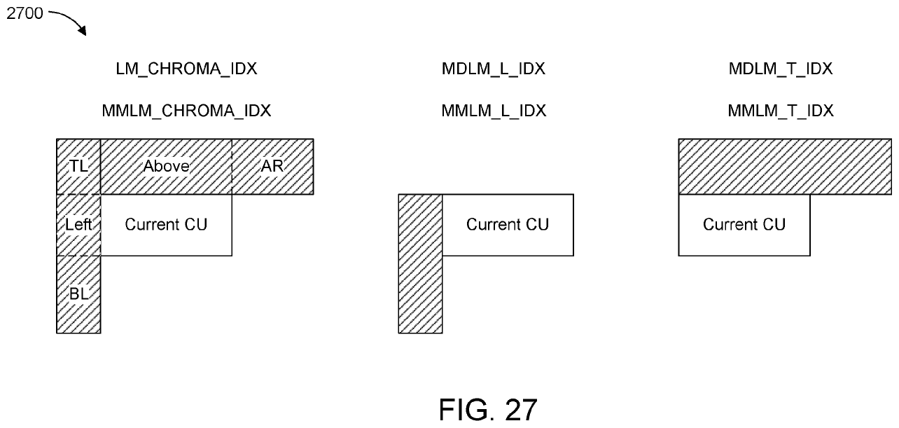

FIG. 9 illustrates an example of a method 900 for chroma prediction using cross-component luma model. Method 900 can be used for implementing any one of the examples of cross-component prediction modes described above: e.g. chroma prediction modes CCLM, MMLM, or CCCM. Depending on the prediction modes, all or part of the method may be implemented. At 910, the reference samples (reconstructed neighboring luma and chroma sample values) are selected from the neighborhood of the current CU. The selection of the reference samples, i.e. the reference area, depends here on the chroma prediction mode that is used in the method 900 (e.g. chroma prediction modes CCLM, MMLM, or CCCM). Also, in a variant similarly to CCLM, the shape of the reference area can for CCCM be chosen between 3 shapes for the single model (LM_CHROMA, MDLM_T, MDLM_L) or the multi-model (MMLM_CHROMA, MMLM_T, MMLM_L) as depicted in FIG. 27. FIG. 27 illustrates different shapes of the reference area (grey area) that can be used for single mode or multi-model. In some variant, the luma sample values may be filtered to obtain down-sampled luma samples.

At 920, in case of multi-model, the reference samples are classified in at least two classes using at least one first value determined from the reference samples. For example, in case of two classes, if a reference luma sample value is lower than or equals to the first value, the reference luma sample is classified in the first class, while if the reference luma sample value is higher than the first value, the reference luma sample is classified in the second class.

At 930, the parameters of the CC-model or of the multi-models are derived from the reference luma and chroma sample values. At 940, the CC-model(s) allow deriving the chroma sample prediction values from the co-located (down-sampled) reconstructed luma sample values of the CU.

In the present disclosure, the determination of the CC-model is described for chroma samples. It is to be understood, that as video content usually comprises a luma component and two chroma components (Cb/Cr or U/V depending on the content format), separate CC-models are determined for each chroma component.

The cross-components intra prediction tools (e.g. CCLM, MMLM or CCCM) derive the cross-component model from a set of reference (neighboring) reconstructed luma and chroma samples values situated in the neighborhood of the current CU. However, the signal characteristics (statistics) of these luma reference samples may differ from the signal characteristics of the reconstructed luma samples in the current CU, which impacts the accuracy of the derived CC-model for predicting current CU chroma samples.

According to an aspect of the present disclosure, the method 900 for chroma prediction using cross-component luma model as illustrated in FIG. 9 is modified to better match the signal characteristics of the reconstructed luma samples of the current CU. In some embodiments, the selection of the reference samples is modified. In other embodiments, the reference samples classification is modified. In further other embodiments, both the selection of the reference samples and the reference samples classification are modified.

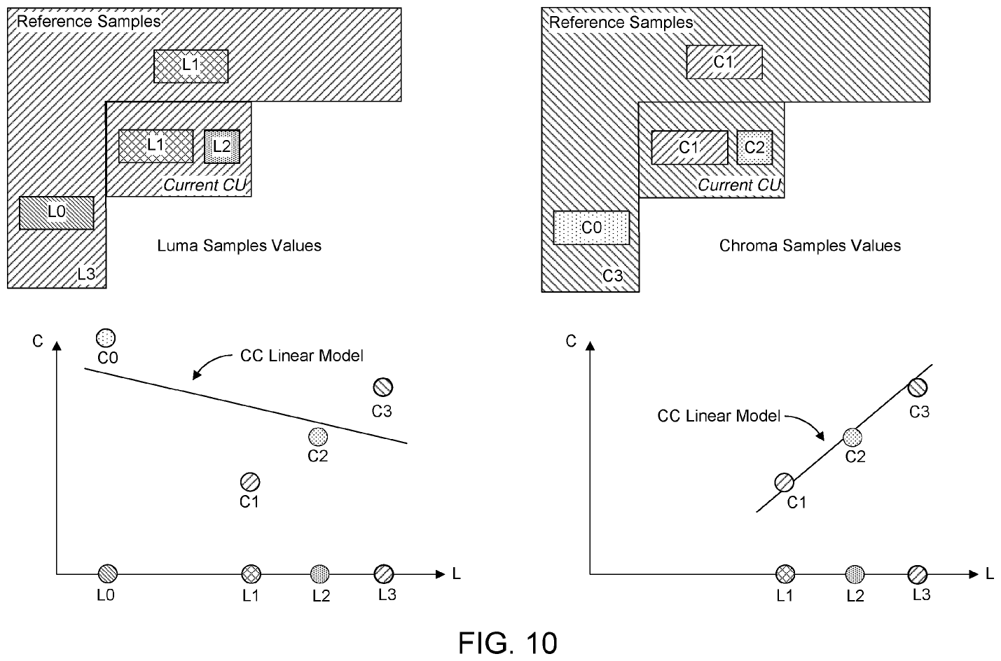

The signal properties of some reconstructed luma sample values in the neighborhood of the current CU may differ significantly from the signal properties of the current CU reconstructed luma sample values. This may impact the efficiency of the derived CC model to predict the chroma samples values from the reconstructed CU luma sample values. For example, in FIG. 10, the top left part shows the reference samples and current CU luma values wherein the current CU shows L3, L1 and L2 luma values and the reference area shows L3, L1 and L0 luma values. The top right part of FIG. 10 shows the reference samples and current CU chroma values wherein the current CU shows C3, C1 and C2 chroma values and the reference area shows C3, C1 and C0 chroma values. The bottom left part shows an example of a CC-model derived using all reference samples of the reference area (L0, L1, L3, CO, C1, C3), while the bottom right part shows an example of a CC-model derived using reference samples of the reference area but not including the L0, CO reference samples.

In the example of FIG. 10, the signal characteristics of the reference samples is different from the one of the current CU, since the color luma value L0 is not in the current CU. Including (L0, C0) or not in the reference samples used to derive the CC model may lead to different linear models.

A method for chroma prediction of a block using at least one cross-component model is provided wherein the at least one cross-component model is obtained from reference luma and chroma samples, based on reconstructed luma samples of the block. The method can be used in any one of a method for encoding the block, a method for encoding an image or a video including the block. Correlatively, the method can also be used in any one of a method for decoding the block, a method for decoding an image or a video including the block. The following embodiments can be applied to any one of the cross-components intra prediction tools in general, such as the ones described above, or other cross-components intra prediction. Any one of the embodiments described below can be implemented in an intra prediction module of an image or video encoder/decoder, such as the intra prediction module 260 of the encoder 200 and the intra prediction module 360 of the decoder 300.

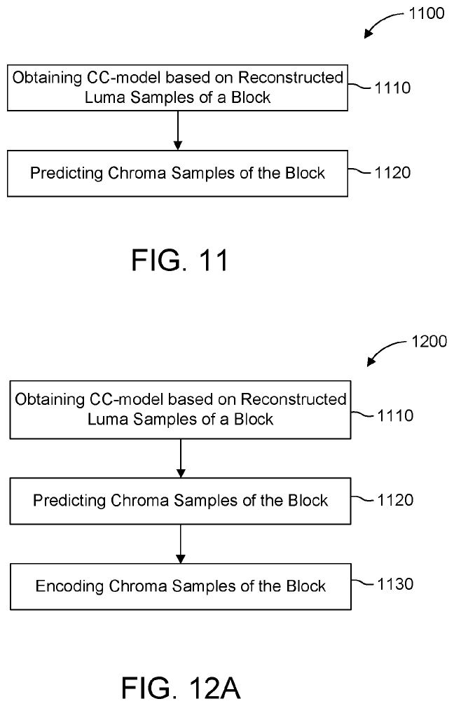

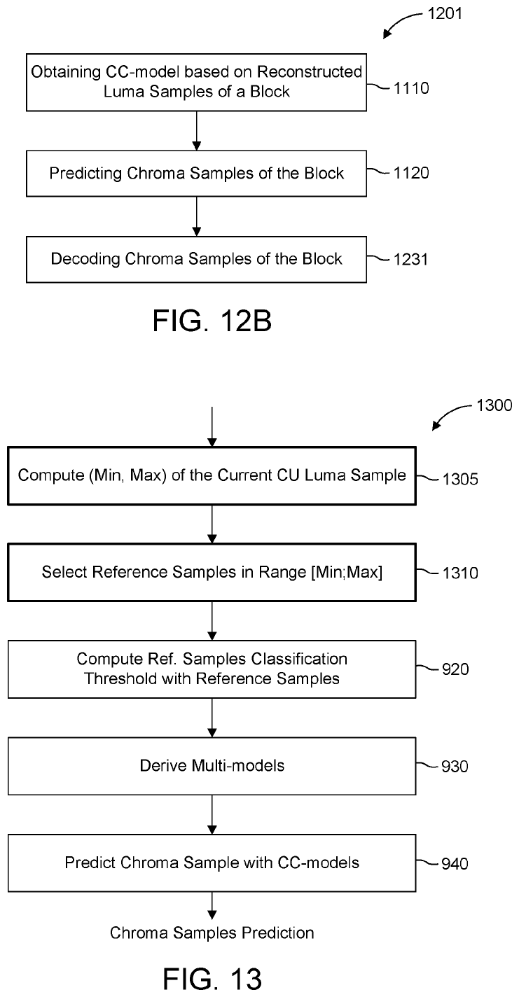

FIG. 11 illustrates a method 1100 for predicting chroma samples of a block using cross-component intra prediction according to an embodiment. At 1110, at least one cross-component model is obtained for the block from reference luma and chroma samples, based on reconstructed luma samples of the block. At 1120, chroma samples of the block are predicted using the at least one cross-component model obtained and the reconstructed luma samples of the block. The predicted chroma samples can then be used for encoding (1230) or decoding (1231) the chroma samples of the block as in the method 1200 and 1210 illustrated in FIGS. 12A and 12B. Encoding the chroma samples is done by determining a residue between the chroma samples of the block and the chroma prediction and encoding the residue. Decoding the chroma samples is done by decoding the residue and adding the residue to the chroma prediction to reconstruct the chroma samples of the block. Some variants of step 1110 or 1120 in method 1100 are described below in relation with FIG. 13-20.

In the embodiment illustrated in FIG. 13, the selection of the reference samples is modified with respect to the method 900 so that reconstructed luma reference samples with same characteristics as the current CU reconstructed luma samples are selected only (1310). For example, at 1305, a range of values representative of the current CU reconstructed luma samples is determined. In a variant, such a range is a range of the current CU reconstructed luma sample values [min, max] where min is the lowest (minimum) luma value in the current CU and max is the highest (maximum) luma value in the current CU.

At 1310, the reference reconstructed luma samples with value within the determined range are selected in the neighborhood of the current CU. The selected reference reconstructed luma samples are then used to derive the CC model (920, 930, 940). Selecting the reference reconstructed luma samples in the neighborhood implies selecting the reference reconstructed chroma samples for deriving the CC-model, as the reference reconstructed chroma samples used for deriving the CC-model correspond to the collocated chroma samples of the selected reference reconstructed luma samples.

In a variant, the values (min, max) used to select the reference reconstructed luma samples are derived from both the average (μ) and the standard deviation (σ) of the reconstructed luma sample values of the current CU. For example, the reconstructed luma sample values of the current CU are modelled as a Normal/Gaussian distribution X˜N(μ, σ²). The probability density function f(x) is given by:

$$f ( x ) = \frac{1}{σ \sqrt{2 π}} {e}^{- \frac{1}{2} {( \frac{x - μ}{σ} )}^{2}}$$

The values (min, max) can be derived for example as the probability that a certain percentage (given amount) of the sample values are between [min; max] range. For instance, one can take 90% of the sample values between [min; max], e.g. F(x)=0,45 is obtained with x=1,64. If X˜N(μ, σ²), then Y˜N(0,1) with

$$Y = \frac{X - μ}{σ} ,$$

and the values (min, max) are derived as (μ−1.64 σ, p+1.64 σ) respectively.

In a variant, the values (min, max) are derived as a combination/function of both the range of the current CU reconstructed luma sample values [min1, max1] and the range (min2, max2) obtained from the average (μ) and the standard deviation (σ) of the reconstructed luma sample values of the current CU and Normal/Gaussian model. For example, (min, max)=(MAX(min1,min2), MIN(max1,max2)), or (min,max)=(average(min1,min2), average(max1,max2)), where MAX returns the maximum value, MIN returns the minimum value, and average returns the average value.

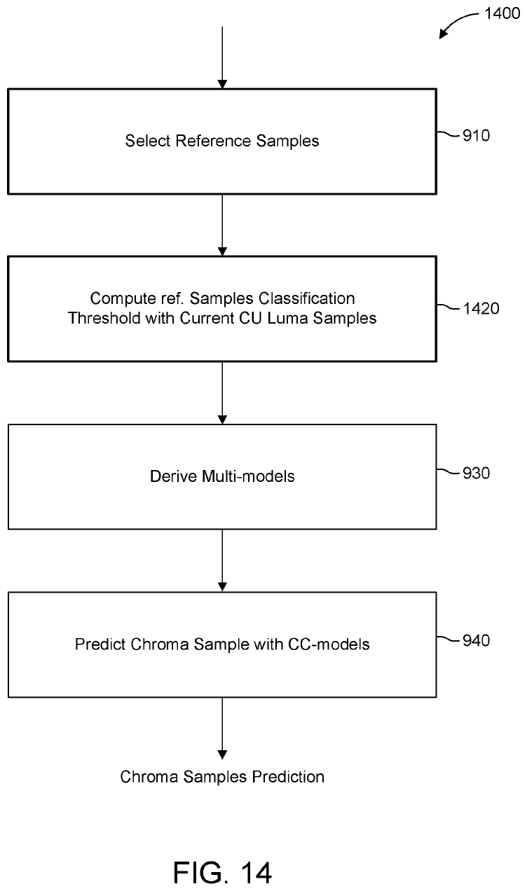

In another embodiment illustrated in FIG. 14, the selection (910) of the reference samples is not modified with respect to the method 900, but the thresholds used to classify the reference samples and to derive several CC-models, are derived (1420) with the reconstructed luma sample values of the current CU. For example, the threshold is the average of the reconstructed luma sample values of the current CU. The other steps (910, 930, 940) of the method 1400 are similar as the ones of method 900.

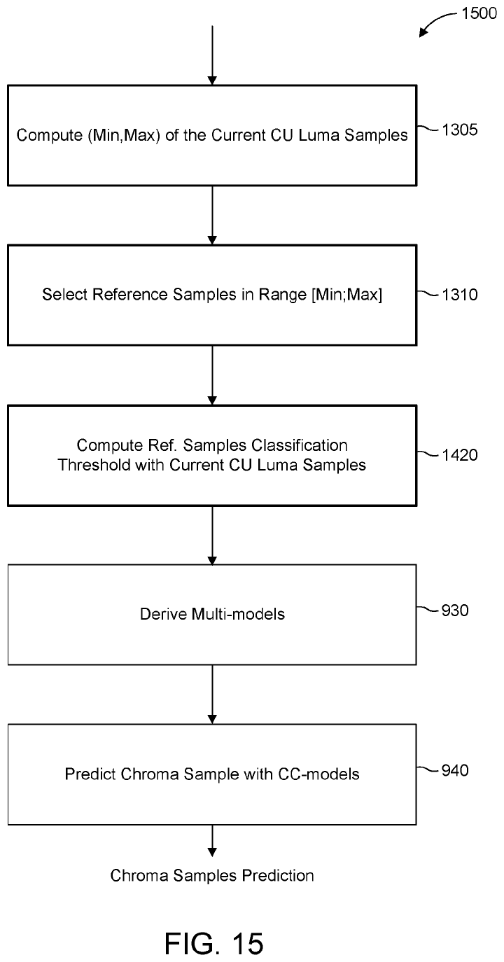

Another embodiment is illustrated in FIG. 15, which is a combination of the embodiments shown in FIGS. 13 and 14. The selection (1310) of the reference samples is modified in a similar way as in FIG. 13. Any variants described with FIG. 13 for determining (1305) the range of luma values [min; max] can be used. The thresholds used to classify the reference samples and to derive several CC-models, are derived (1420) with the reconstructed luma sample values of the current CU. For example, the threshold is the average of the reconstructed luma sample values of the current CU. In the variant that the range [min; max] is determined using the probability function, the threshold can be determined as the average of the reconstructed luma sample values of the current CU within the range. At 1420, the classification is done using the determined threshold, only the selected reference samples are classified. The other steps (930, 940) of the method 1500 are similar as the ones of method 900.

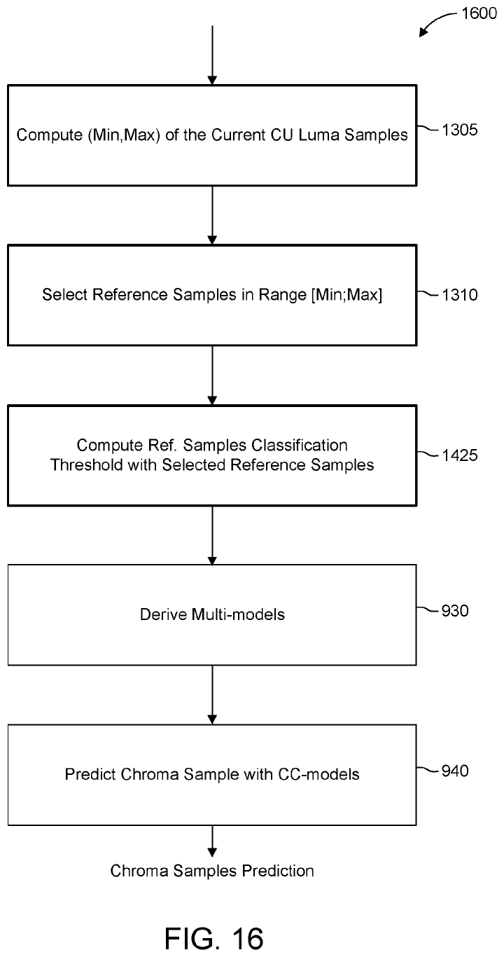

In another variant shown in FIG. 16, the selection (1310) of the reference samples is modified in a similar way as in FIG. 13 using any one of the variants. The threshold is determined (1425) as the average of the selected reconstructed reference luma sample values (1310). In this variant, the threshold is determined after (1310), that is using the selected reference samples with same characteristics as the reconstructed luma samples of the current CU. For example, the threshold is the average of the reconstructed luma sample values both in the neighborhood of the current CU (for example the reference area in FIG. 8) and with value in the range [min; max]. At 1425, the selected reference samples are classified using the determined threshold. The other steps (930, 940) of the method 1600 are similar as the ones of method 900.

In another variant, the threshold is determined as the average or a weighted average of the reconstructed luma sample values of the current CU and the selected reconstructed reference luma sample values. In another variant, the threshold is computed as the average or a weighted average of the average of the reconstructed luma sample values of the current CU and the average of the selected reconstructed reference luma sample values. Using a weighted average could be used for instance to correct values obtained from one method with values obtained from another method. For example, a first threshold Threshold1 is the average of the reconstructed luma sample values of the current CU, a second threshold Threshold2 is the average of the selected reconstructed reference luma sample values, the final threshold can then be determined as a weighted combination of the first and second thresholds, for instance ¾ Threshold1+1/4 Threshold2, other weights are also possible.

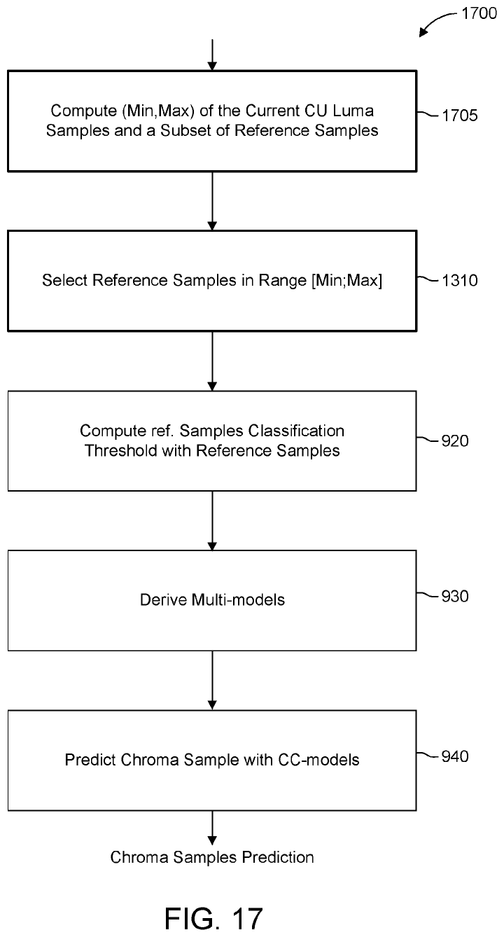

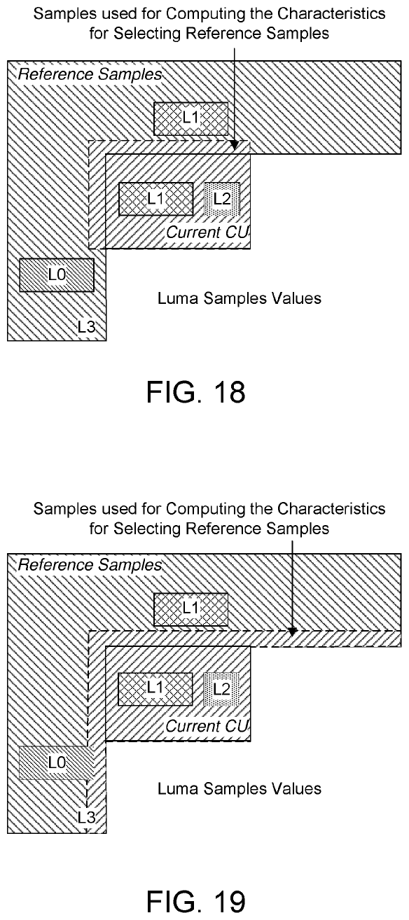

Instead of determining the characteristics used for selecting the reference samples using the current CU reconstructed luma samples only, in another variant illustrated on FIG. 17, such characteristics are calculated using both the current CU reconstructed luma samples and a subset of reference reconstructed luma samples (method 1700, FIG. 17). At 1705, the range [min; max] is determined by determining the minimum and maximum luma values among the luma values of the current CU samples and a subset of reconstructed luma samples in the reference area. For example, the subset of reference reconstructed luma samples is made of the first n lines of reference reconstructed luma samples located above the current luma block and the first n columns of reference reconstructed luma samples located on the left side of the current luma block, as illustrated in FIG. 18. In FIG. 18, the area used for determining the characteristics for selecting the reference samples is shown as the area surrounded by the dotted line.

Still in the embodiment of FIG. 17, in another example, the subset of reference reconstructed luma samples is made of the first n lines of reference reconstructed luma samples located above the current luma CU and the first n columns of reference reconstructed luma samples located on the left side of the current luma CU, as illustrated in FIG. 19. In this example, the area includes the reference reconstructed luma samples located on the above-right side of the current luma CU and those on the bottom-left side of the current luminance CU.

In any of these examples, the other steps (1310, 920, 930, 940) of the method 1700 are similar as the ones of method 900 or 1300. It is to be noted that the examples illustrated with FIGS. 18 and 19 can be combined with any one of the variants described above in relation with FIG. 13-16.

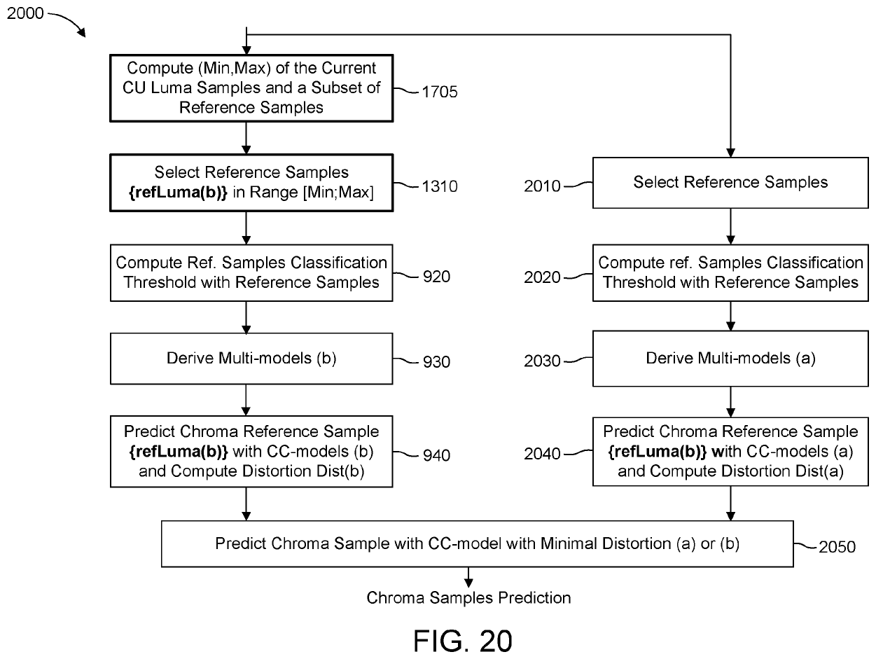

In another embodiment illustrated on FIG. 20, two CC-models (or CC-multi-models) {(a),(b)} are derived.

A CC6(multi-)model (a) is derived (2030) using all the reconstructed luma reference samples {refLuma(a)} in the neighboring area (a). For deriving the CC-(multi-)model (a), the reference samples are selected at 2010 in a similar manner as in method 900 (910). If CC-multi-model is used, at 2030, the threshold is determined for the reference samples in the neighboring area and the reference samples are classified. The CC-model or CC-multi-models (a) is/are derived at 2030. These steps are similar to what is done in method 900.

A CC-(multi-)model (b) is derived (930) using the reconstructed luma reference samples {refLuma(b)}which have the same characteristics as the current CU reconstructed luma samples only. For deriving the CC-(multi-)model (b), any one of the embodiments/variants described with FIG. 13-19 can be used. For example, at 1705, the range [min; max] is determined using the reconstructed luma samples of the current CU and a subset of reconstructed luma samples in the reference area. Other variants described above can also be used. At 1310, the reference reconstructed luma samples are selected using the determined range providing the set of selected reference reconstructed luma samples {refLuma(b)}. Steps 920, 930, 940 are then similar to the ones of method 900 for deriving the CC-(multi-)model (b), but any other embodiments described above with FIG. 13-19 can also be used.

At 2040, the chroma samples of the reference samples in the set of selected reference reconstructed luma samples {refLuma(b)} are predicted using the CC (multi-)model (a) derived at 2030 and the distortion Dist(a) is determined between the reconstructed chroma reference samples in the set of selected reference reconstructed luma samples {refLuma(b)} and the predicted chroma values.

At 940, the chroma samples of the reference samples in the set of selected reference reconstructed luma samples {refLuma(b)} are predicted using the CC (multi-)model (b) derived at 930 and the distortion Dist(b) is determined between the reconstructed chroma reference samples in the set of selected reference reconstructed luma samples {refLuma(b)} and the predicted chroma values.

The distortion can be the sum of absolute difference (SAD) or the sum of the squared differences for example, or any other metrics.

The best CC-(multi-)model (e.g. with minimal distortion) is selected between (a) or (b) at 2050.

As the distortions are determined on the reconstructed chroma samples in the reference area, the same process can be done at the encoder and decoder, so there is no need to signal which CC-model is used. This variant can be extended to the case where one or more of the embodiments described above in relation with FIG. 13 to 19 are tested against each other and the embodiment providing the best CC-model (i.e. the minimum distortion) is selected for predicting the chroma samples of the current CU. The selected CC-model can be a multi-model whose cross-component relationship between luma and chroma depends on the luma value. Thus, in the case of a multi-model, the CC-model used for predicted a chroma sample of the current CU depends on the co-located reconstructed luma sample.

In another variant of FIG. 20, the distortion is computed by the encoder with the original chroma samples and the predicted chroma values in the current CU with each CC-(multi-)model, and the best CC-model to use is signaled to the decoder. For instance, the best CC-model is the one providing the lowest distortion or the lowest rate-distortion cost taking into account the cost to signal the CC-model and eventually the cost of coding the chroma residue resulting from the prediction. The selected CC-model can be a single CC-model or a multi-model. One or more of the embodiments described above in relation with FIG. 13 to 19 can be tested against each other, as well as other cross-component prediction modes.

In this variant, the signaling of the selected CC-(multi-)model to the decoder can be done at 1230 of FIG. 12A when encoding the chroma samples of the block/current CU. Thus, the bitstream generated by the encoder comprises data representative of the CC-model or multi-model used for predicting the chroma samples of the block.

On the decoding side illustrated for example by FIG. 12B, at 1110, the decoder decodes the data representative of the CC-model or multi-model to be used for predicting the chroma samples of the block and derives the CC-model or multi-model based on the decoded data. In this variant, the signaling provides indication to which embodiments or other cross-component prediction modes to use for predicting the chroma samples of the block/current CU.

In any one of the embodiments and variants described above, the size of the reference area from which the reference reconstructed luma samples are selected can be of any size, as long as there are sufficient samples selected for deriving the CC-model. For instance, the reference area can be defined as illustrated with FIG. 18 or 19 with n being 1. In another example, the neighboring reconstructed luma samples used to compute the CC-model prediction can be extended to a larger number of lines and columns (i.e. n>1). For example, the enlarged area of reference reconstructed luma samples is made of the reference samples in the dashed area of FIG. 18 or 19, but outside the current CU or the one defined in relation with FIG. 8.

In some embodiments, the reference area and/or selection of reference samples in the reference area is/are signaled with the video data, for example in a bitstream.

In an embodiment, when the current CU is coded with CC-mode (e.g. CCLM, MMLM or CCCM), a first indicator indS (i.e. a flag or an index) is coded to indicate whether the process for selecting reference samples is changed or not, an example of values for the first indicator indS is illustrated in table 1 (a) below). For example, the first indicator indS indicates whether the process 1110 of FIG. 11 is used or not. In other variants, the first indicator indS can also indicate whether the process for deriving the CC-model is changed or not or which method to use to derive the model. For example, the first indicator indS may indicate whether or not to use the selection of the reference samples as described in any one of the embodiments described with FIG. 11-20.

In another embodiment, a second indicator indM indicates the reference area. For example, the second indicator indM indicates which neighboring area (e.g. region A or region B) to use for selecting the reference samples. An example of values of the second indicator indM is illustrated in table 1(b) below. The indicator indS can be coded before or after the coding of the indicator indM. The coding of any one of the indicator(s) indS or indM can depend on the Cross-component coding tool. For instance, one or both of the indicators can be coded for one CC coding tool (ex: CCCM) but not for another CC-model (ex: CCLM), or can be coded for several cc-models (ex: CCLM and CCCM).

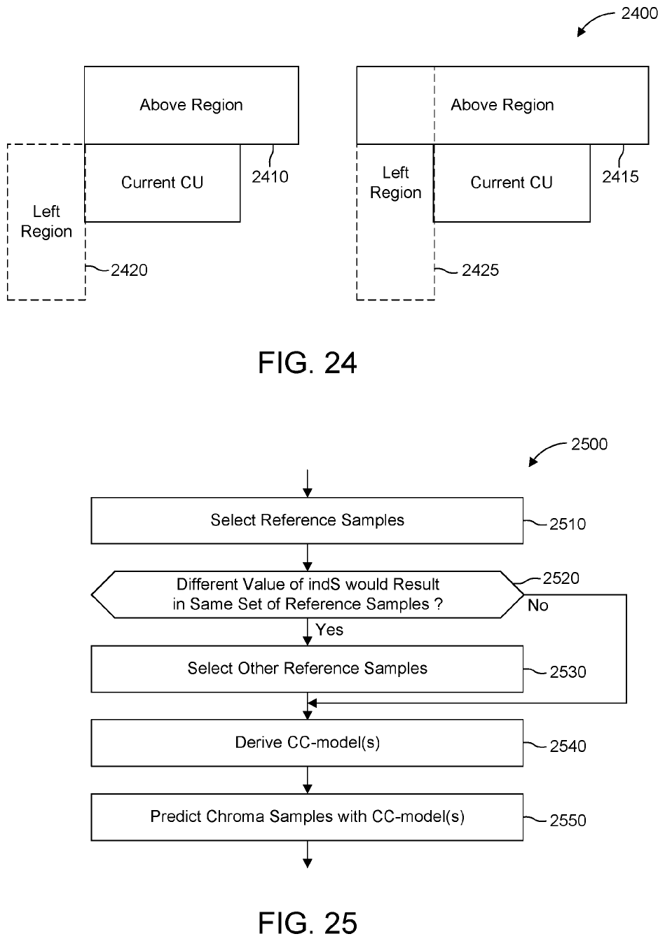

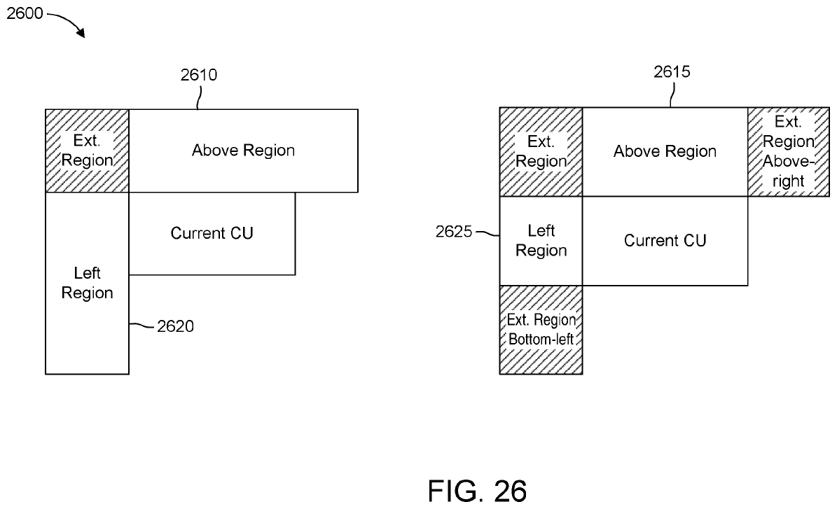

For example, in the example of FIG. 24, the second indicator indM indicates which region among the above region (2410), the left region (2420) or the above and left region (2410 and 2420), is the reference area. In other words, the second indicator indM indicates which region is used to derive the CC-model. The different regions may or may not superimpose (for example 2415, 2425 on FIG. 24). Other examples of neighboring regions are depicted in FIG. 26.

Advantageously, the coding of indS can be combined with other flags or index. For instance, the indS can be combined with indM. Some examples of combination are illustrated on the table 1(c) below.

TABLE 1

| | | | | c | | |
|---|---|---|---|---|---|---|
| a | | b | | | | Selection of |
| | Reference | | Reference | | | ref. samples |
| | samples used | | samples used | indS and | | in the |
| | to derive CC | | to derive CC | indM | Selection of the | reference |
| indS | model | indM | model | combined | reference area | area |
| 0 | Use all | 0 | Use all samples | 00 | Use samples in | no |
| | samples in the | | in region A | | the region A | |
| | reference area | | | | | |
| 1 | selection of | 1 | Use all samples | 01 | Use samples in | no |
| | the reference | | in region B | | the region B | |
| | samples in the | | | | | |
| | reference area | | | | | |
| | L→ | 2 | Use all samples | 10 | Use samples in | no |
| | | | in region A + B | | the regions | |
| | | | | | A + B | |
| | | | | 11 | Use samples in | yes |
| | | | | | the regions | |
| | | | | | A + B | |

In table 1, region A and region B can be for example any one of the regions illustrated in FIG. 24 or 26 (above region, left region, above left region -ext. region-, ext. region above-right, ext. region bottom-left) or any combination of these regions.

In a variant, the process for selecting reference samples and/or deriving the CC-model when indS=1 (i.e. when the first indicator indicates that reference samples are selected in the reference area according to any one of the embodiments described with FIG. 13-20) can be changed under certain circumstances. For instance, when the first indicator indS is set to one, either by decoding or inference, the process for selecting reference samples is changed if the method for selecting the reference samples does not apply, or if selecting the reference samples in the reference area has no effect in the process of collecting the reference samples in the considered region (i.e. the selection of reference samples in the reference area for determining the CC-model provides the same result as without any selection), or if a ratio of selected reference samples (i.e. the number of selected reference samples divided by the total number of samples in the reference area) is below (or above) a given value. Such a value can be for example 20% of reference samples are selected.

FIG. 25 illustrates an example of a method 2500 for chroma prediction using cross-component model according to another embodiment. At 2510, reference samples are selected in the reference area according to any one of the embodiments described above.

For example, in case the first indicator indS and the second indicator indM are both coded (e.g. table 1 a,b) but all the reference samples in the reference area are still within the range [min, max] of the current CU reconstructed luma sample values, then indS=O or indS=1 would give the same result. In this case (test at 2520 is true), the process for selecting the reference samples is changed when indS=1 for example. For example, if the reference area is determined as being region A (for example indM=0), if indS=1 and all the reference samples in the region A are within [min;max] then the reference area is modified and samples are selected within the modified area at 2530. At 2540, the CC-model is derived from the samples selected in the modified reference area and at 2550, the chroma samples of the current CU are predicted using the derived CC-model.

In a variant, at 2520, a ratio of samples selected in the reference area is determined. Let's N0 be the number of reference samples in the reference area which are not within the range [min, max] of the current CU reconstructed luma sample values and N1 is the number of samples in the reference area. At 2520, in the case that the first indicator indS and the second indicator indM are both coded (e.g. table 1 a,b) but the ratio of NO divided by N1 is below a given value (test at 2520 is true), then the process for selecting the reference samples is changed when indS=1 for example. For example, if the reference area is determined as being region A (for example indM=0), if indS=1 and the test at 2520 is true (the ratio is below a given value), then the reference area is modified at 2530. At 2540, the CC-model is derived from the samples selected in the modified reference area and at 2550, the chroma samples of the current CU are predicted using the derived CC-model.

In another variant, when indS is equal to 1, the shapes of the reference areas are modified and all samples of the reference area are selected whatever the values of the reference samples. In this case, the test (2520) is replacing with testing the value of indS.

In another variant, when indS is equal to 1, both the shape of the reference area is modified and the reference samples that are selected in the modified reference area are the reference samples that are within the range [min, max] of the current CU reconstructed luma sample values.

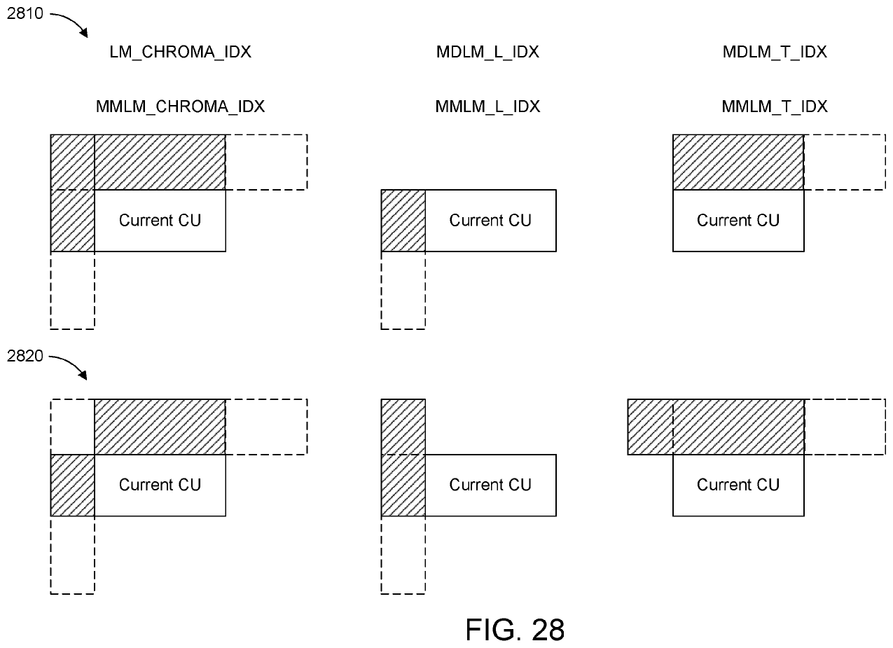

At 2530, the reference area can be modified by adding samples from another region (for instance region B) or replacing the selected samples of the reference area with other samples in another region or removing a subset of selected samples (for example removing the top-left region in case of the reference area being either 2415 or 2425). Some examples of modified areas by adding/replacing/removing subset of samples {TL,AR,BL, Above,Left} from the reference areas 2700 illustrated in FIG. 27 (for indS=0) are depicted in FIG. 28 (2810) or (2820) (when indS=1).

In a variant, the test (2520) is made on a subset (for example region 2615 in FIG. 26) of samples in the reference area (for example 2610 in FIG. 26), for example before adding samples from the other (extended) region. This may have the advantage that if the first indicator indS=1 and the test at 2520 is true, then the other reference samples of the reference area are not added, the reference area becomes the subset region (2615), whereas if the test at 2520 is false, the other reference samples of the reference area are used (i.e. region 2610 in FIG. 26). This variant emulates the removing of reference samples from the reference area. Examples of extended/other regions are depicted in FIG. 26.

In another example, at 2530, the top-left area is added to the reference area, for instance when the reference area is the left region (2420) or the above region (2410) as in FIG. 24 in case the two regions are not superimposed.

In another example, at 2530, the whole reference area is replaced by another region, for instance the top-left area is used as the reference area instead of the left or above region.

In another example, at 2530, another method to derive the CC-model is selected.

In another variant, the second indicator indM is first coded and the first indicator indS is either coded or inferred depending on the decoded value of the second indicator indM. In this way, the selection of reference samples in the reference area can be activated only for specific regions.

In another variant that can be combined with any of the previous variants/embodiments, the first indicator indS is coded only for some values of the current block size. For instance, the first indicator indS is coded only for block having a size or a width and/or height above a given value. In another example, the first indicator indS is coded only for block having a size or a width and/or height less than a given value. In these examples, when the first indicator indS is not coded, its value is inferred, for instance by activating the selection of reference samples in the reference area by default for those blocks, or by de-activating the selection of reference samples in the reference area by default for those blocks.

In another variant, the first indicator indS is representative of an information indicating a change of the method for deriving the CC-model. For instance, a first method for deriving the CC-model is based on a cross-component linear model (CCML) described in relation with FIG. 4 (single CC-model of the CU), and a second method is based on the cross-component multi-model linear model (MMLM) described in relation with FIG. 5. The first and second method can also be any other methods described herein for deriving the CC-model, for instance the convolutional model described in relation with FIG. 7. In this variant, the first method or the second method is used depending on the size of the block. For instance, for blocks having a size equal to or above a given value, the second method is used and for blocks having a size below the given value, the first method is used. Therefore, depending on the size of a block, one of the first or the second method is used for the block when the first indicator indS is not coded or if the first indicator indS is coded and is set to 0. When the first indicator is coded and is set to 1 for the block, then the other one of the first and the second methods is used for the block. In this variant, the first indicator indS is used to change the method for deriving the CC-model.

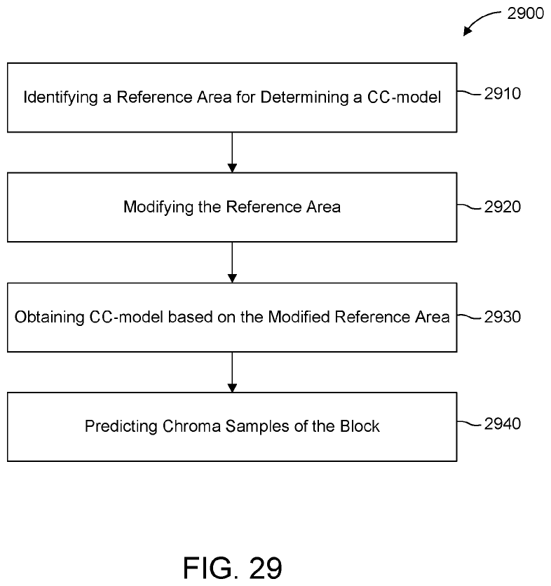

FIG. 29 illustrates an example of a method 290 for predicting chroma samples of a block of an image according to an embodiment.

At 2910, a reference area is identified for determining a cross-component model for the block. In a first variant, the reference area is identified according to the mode used for determining the cross-component model, that is depending on the mode for CC-model (such as the modes for CCLM, modes of Multi-model LM, or CCCM) used as the one described above with reference to FIG. 4-8. In another variant, the reference area is identified by an indicator indicating a specific reference area, for instance one of the shapes illustrated on FIG. 27 wherein reference areas are shown in grey. In some embodiments, the indicator indicating the reference area is encoded with or decoded from video data, the indicator is for instance the indM indicator described above.

At 2920, the reference area is modified according to at least one characteristic of the block.

In a first variant, the reference area is modified by selecting reference samples based on reconstructed luma samples of the block, for instance the selection can be made according to any one of the variants described above in reference with FIG. 11-20.

In a second variant, the reference area is modified responsive to a third indicator indT. The indicator indT can be signaled with the video data or inferred from reconstructed data. For instance, the indicator indT can be inferred from the mode used for determining the CC-model or from other characteristics of the block, such as a size of the block, or a shape of the block.

In this second variant, the indicator indT is representative of a modification of the reference area, for instance, the indicator indicates a removal of a part of the reference area, or an extension of the reference area or a replacement of the reference area with another part of reconstructed samples. For instance, the indicator provides for modifying one of the reference areas illustrated on FIG. 27 to a reference area illustrated on FIG. 28, wherein the parts serving as modified reference areas are shown in grey and the parts removed from the reference areas are shown with dashed lines.

For instance, as illustrated in FIG. 27, the reference area identified at 2910 can comprise at least one of: a part of a reconstructed block located above the block (current CU in FIG. 27), a part of a reconstructed block located above and right to the block, a part of a reconstructed block located left to the block, a part of a reconstructed block located above and left to the block and a part of a reconstructed block located below and left to the block.

Modifying the reference area thus can comprise at least one of: adding or removing a part of a reconstructed block located above the block, adding or removing a part of a reconstructed block located above and to the right of the block as shown in FIG. 28, adding or removing a part of a reconstructed block located to the left of the block, adding or removing a part of a reconstructed block located below and to the left of the block as shown in FIG. 28, adding or removing a part of a reconstructed block located above and to the left of the block as shown in FIG. 28.

In a third variant that can be combined with the previous variants, modifying the reference area is responsive to an indicator indicating whether the reference area has to be modified or not.

For instance, the indicator is similar to the indicator indS described above. In other examples, the indicator indicating whether the reference area has to be modified or not can be set on the encoder side by determining rate-distortion cost for predicting the chroma samples using the different available reference areas. In this example, the indicator indicating whether the reference area has to be modified is signaled with the video data. For instance, on the encoder side, all available candidate modified reference areas are tested for determining a CC-model against the initial reference area (reference area identified at 2910), and the candidate modified reference area or the initial reference area providing a lowest cost that may takes into account a distortion and a coding cost for predicting and coding the chroma samples is selected, the indicator is set accordingly. In some embodiments, the indicator is set to a value that indicates both whether the reference area has to be modified and which modification is to be performed if the reference area is to be modified.

In this third variant, on the decoder side, at 2920, the reference area is modified responsive to a determination that the reference area has to be modified. This determination is based on the indicator indicating whether the reference area has to be modified, the indicator can be decoded from video data or inferred from the CC-model to use, or the size of the block.

At 2930, at least one cross-component model is obtained for the block from reference luma and chroma samples, based on the reference area modified at 2920. At 2940, chroma samples of the block are predicted using the at least one cross-component model obtained and the reconstructed luma samples of the block. The predicted chroma samples can then be used for encoding or decoding the chroma samples of the block as in the methods 1200 and 1201 illustrated in FIGS. 12A and 12B.

The above embodiments have been described with the examples of regions as illustrated in FIGS. 19, 24, 26, 27 and 28 but the above embodiments can also apply to more than one region and different region shapes and sizes.

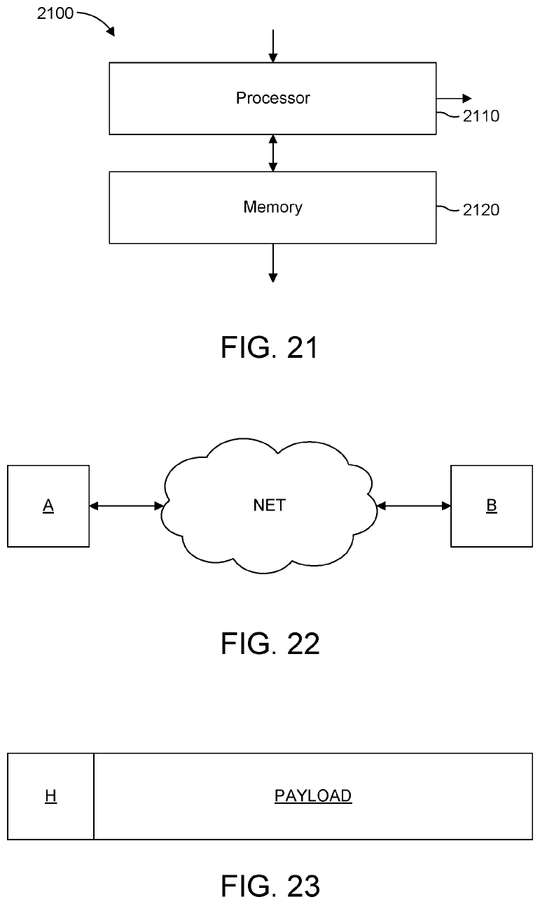

FIG. 21 illustrates a block diagram of a system within which aspects of the present embodiments may be implemented, according to another embodiment. FIG. 21 shows one embodiment of an apparatus 2100 for predicting chroma samples using CC-model, according to any one of the embodiments described herein.

The apparatus comprises Processor 2110 and can be interconnected to a memory 2120 through at least one port. Both Processor 2110 and memory 2120 can also have one or more additional interconnections to external connections.

Processor 2120 is also configured to either obtain, for at least one block of an image, at least one cross-component model from reference luma and chroma samples, based on reconstructed luma samples of the block, and predict chroma samples of the block based on the at least one cross-component model and the reconstructed luma samples of the block, using any one of the embodiments described herein. For instance, the processor 2021 is configured using a computer program product comprising code instructions that implements any one of embodiments described herein.

In an embodiment, illustrated in FIG. 22, in a transmission context between two remote devices A and B over a communication network NET, the device A comprises a processor in relation with memory RAM and ROM which are configured to implement a method for encoding an image or a video, as described with FIG. 1, 2, 12A and the device B comprises a processor in relation with memory RAM and ROM which are configured to implement a method for decoding an image or a video as described in relation with FIGS. 1, 3, 12B. Depending on embodiments, the devices A and B are also configured for predicting chroma samples using CC-model as described in relation with FIGS. 13-20.

In accordance with an example, the network is a broadcast network, adapted to broadcast/transmit encoded image or video from device A to decoding devices including the device B.

FIG. 23 shows an example of the syntax of a signal transmitted over a packet-based transmission protocol. Each transmitted packet P comprises a header H and a payload PAYLOAD. In some embodiments, the payload PAYLOAD may comprise coded image or video data according to any one of the embodiments described above. In a variant, the signal comprises data representative of a CC-model or CC-multi-model to be used for predicting chroma samples of a block of the image or video.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

In the present disclosure, unless stated otherwise, the CC-model stands for Cross-Component model and multi-model relates to multiple cross-component models (CC-models) derived for predicting chroma samples of a same unit or block.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “AB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of re-sampling filter coefficients. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method comprising, for at least one block of an image:
identifying a reference area for determining at least one cross-component model from reference luma and chroma samples,
selecting, in the reference area of the block, reference luma samples and co-located chroma samples whose luma value is within a range of values of reconstructed luma samples of the block ranging from a minimum luma value of the reconstructed luma samples of the block to a maximum luma value of the reconstructed luma samples of the block,
determining the at least one cross-component model, based on the selected reference luma samples and co-located chroma samples,
predicting chroma samples of the block based on the at least one cross-component model and reconstructed luma samples of the block, and
encoding or decoding the block based on the predicted chroma samples.

2. An apparatus, comprising one or more processors, wherein the one or more processors are operable to, for at least one block of an image:
identify a reference area for determining at least one cross-component model from reference luma and chroma samples,
select, in the reference area of the block, reference luma samples and co-located chroma samples whose luma value is within a range of values of reconstructed luma samples of the block ranging from a minimum luma value of reconstructed luma samples of the block to a maximum luma value of reconstructed luma samples of the block,
determine the at least one cross-component model, based on the selected reference luma samples and co-located chroma samples,
predict chroma samples of the block based on the at least one cross-component model and reconstructed luma samples of the block, and
encode or decode the block based on the predicted chroma samples.

3-8. (canceled)

9. The method of claim 1, wherein the range of values of the reconstructed luma samples of the block is derived from an average and a standard deviation of the reconstructed luma samples of the block and a probability density function such that a given amount of reconstructed luma samples of the block has a value within the range.

10. The method of claim 1, wherein determining the at least one cross-component model comprises:
determining a first value from at least one of the reconstructed luma samples of the block or the selected reference luma samples, and
classifying the selected reference luma samples based on the first value,
wherein a cross-component model is determined for each class based on the selected reference luma samples and co-located chroma samples of the class.

11. The method of claim 10, wherein the first value is determined as an average of the reconstructed luma samples of the block or an average of the selected reference luma samples.

12. The method of claim 10, wherein the first value is determined from the reconstructed luma samples of the block and the selected reference luma samples.

13. The method of claim 1, wherein selecting, in the reference area of the block, reference luma samples and co-located chroma samples, is further based on a subset of reference luma samples.

14. The method of claim 13, wherein the range of values is determined from the reconstructed luma samples of the block and from the reference luma samples of the subset.

15. The method of claim 13, wherein the subset of reference luma samples comprises at least one of samples located in one or more lines above the block, samples located in one or more columns on the left of the block, samples located in one or more lines above the block and on the right above of the block, samples located in one or more columns on the left of the block and at the bottom left of block.

16. The method of claim 1 further comprising:
determining at least one first cross-component model based on all the reference luma samples and co-located chroma samples,
determining at least one second cross-component model based on the selected reference luma samples and co-located chroma samples,
determining first predicted chroma samples of the selected reference luma samples using the first cross-component model and second predicted chroma samples of the selected reference luma samples using the second cross-component model, and
selecting the first or the second cross-component model based on a first distortion determined between the selected reference chroma samples and the first predicted chroma samples and on a second distortion determined between the selected reference chroma samples and the second predicted chroma samples.

17. (canceled)

18. The method of claim 1, wherein a first indicator is obtained, and wherein the first indicator indicates whether the at least one cross-component model is determined based on the selected reference luma samples and co-located chroma samples or based on all reference luma samples and co-located chroma samples in the reference area.

19. The method of claim 1, wherein a second indicator indicates the reference area.

20-21. (canceled)

22. The method of claim 18, wherein: if the first indicator indicates that the at least one cross-component model is determined based on the selected reference luma samples and co-located chroma samples, selecting, in the reference area of the block, reference luma samples and co-located chroma samples is responsive to a determination that:
a ratio determined by a number of reference luma samples in the reference area which are within the range divided by a number of samples in the reference area is below or above a given value.

23-24. (canceled)

25. The method of claim 18, wherein, if the first indicator indicates that the at least one cross-component model is determined based on the selected reference luma samples and co-located chroma samples, selecting, in the reference area of the block, reference luma samples and co-located chroma samples is further responsive to a determination that all reference luma samples in one first part of the reference area are within the range, and the reference area is limited to the first part of the reference area.

26-30. (canceled)

31. A non-transitory computer readable medium storing executable program instructions to cause a computer executing the program instructions to perform a method according to claim 1.

32. A device comprising:
an apparatus according to claim 2; and
at least one of (i) an antenna configured to receive a signal, the signal including data representative of the image, (ii) a band limiter configured to limit the received signal to a band of frequencies that includes the data representative of the image, or (iii) a display configured to display the image.

33. (canceled)

34. The apparatus of claim 2, wherein the range of values of the reconstructed luma samples of the block is derived from an average and a standard deviation of the reconstructed luma samples of the block and a probability density function such that a given amount of reconstructed luma samples of the block has a value within the range.

35. The apparatus of claim 2, wherein the one or more processors being operable to determine the at least one cross-component model comprises the one or more processors being operable to:
determine a first value from at least one of the reconstructed luma samples of the block or the selected reference luma samples, and
classify the selected reference luma samples based on the first value,
wherein a cross-component model is determined for each class based on the selected reference luma samples and co-located chroma samples of the class.

36. The apparatus of claim 2, wherein the one or more processors being operable to select in the reference area of the block, reference luma samples and co-located chroma samples, is further based on a subset of reference luma samples and the range of values is determined from the reconstructed luma samples of the block and from the reference luma samples of the subset.

37. The apparatus of claim 36, wherein the subset of reference luma samples comprises at least one of samples located in one or more lines above the block, samples located in one or more columns on the left of the block, samples located in one or more lines above the block and on the right above of the block, samples located in one or more columns on the left of the block and at the bottom left of block.
